(19) United States
(12) Patent Application Publication
(10) Pub. No.: US 2004/0068452 A1
(43) Pub. Date: Apr. 8, 2004

(54) Computer-implemented method and system for determining and reporting VAT information and amounts for business transactions

(76) Inventors: Ina Ullrich, Koeln (DE); Uwe Vosen, Siegburg (DE)

Correspondence Address: BROOKS KUSHMAN P.C./FGTL, 1000 TOWN CENTER, 22ND FLOOR, SOUTHFIELD, MI, 48075-1238, US

(21) Appl. No.: 10/065,315

(22) Filed: Oct. 2, 2002

(51) Int. Cl. G06F 17/60

(52) U.S. Cl. 705/35

(57) ABSTRACT

One aspect of the present invention relates to a computer-implemented method and system for determining and reporting value added tax information of a business transaction. A preferred method embodiment includes receiving transaction information from a plurality of computerized invoice systems, determining value added tax information based on the transaction information, transmitting the value added tax information to the plurality of computerized invoice systems, receiving a value added tax amount for the business transaction determined by the plurality of computerized invoice systems based on the value added tax information, and generating an at least one report based on the value added tax amount and the value added tax information.

### BACKGROUND OF THE INVENTION

1. Field of the Invention

At least one aspect of the present invention relates generally to a computer-implemented method and system for determining and reporting VAT information and amounts for business transactions. One aspect of the reporting feature includes reconciliation of VAT information and amounts.

2. Background Art

Value added taxes (“VATs”) and related taxes are often imposed on business transactions by countries across the entire world. Taxing authorities commonly require businesses to compute and report VAT information. For example, list result export and import reports are typically created for cross-border shipments within the European community. Other reports commonly produced by businesses can include domestic VAT, acquisition tax (“AT”) reports, reverse charge (“RC”) and aggregate sales list (“ASL”) reports. Additionally, businesses typically reconcile their internal accounting numbers (i.e., general ledger balances and accounts receivable) with the reported VAT, AT, RC and ASL values.

Businesses often create multiple invoice systems to compute, report and reconcile VAT information relating to its business transactions. Different invoice systems often use similar methods to compute VAT information. Consequently, businesses experience inefficiencies due to the redundancies between different invoice systems. Additionally, each invoice system commonly uses a different reporting format. As a result, reconciling internal accounting numbers with the values found in the reports is often difficult and cumbersome.

Software vendors have also created systems with VAT calculation functionality. For example, the World Tax System, offered by Tax Ware, includes VAT decision making functionality. The Auto VAT system, offered by Corporate VAT Management, includes functionality to produce quarterly invoice collection reports. These systems do not offer functionality to reconcile accounting numbers via the general ledger. Moreover, these systems are limited in geographic scope.

A computer-implemented method and system for consistently determining VAT information for business transactions is needed. Additionally, a computer-implemented method and system is needed to generate consistent VAT reports, including reconciliation of VAT information from a set of transactions that can originate from multiple invoice systems. Moreover, a computer-implemented method and system is needed that provides VAT information for European countries as well as the rest of the world.

### SUMMARY OF INVENTION

One aspect of the present invention relates to a computer-implemented method and system for determining and reporting value added tax information of a business transaction. One object of the present invention is to provide a computer-implemented method and system for consistently determining VAT information for business transactions. Another object of the present invention is to provide a computer-implemented method and system for generating consistent VAT reports, including reconciliation of VAT information from a set of transactions that can originate from multiple invoice systems. Yet another object of the present invention is to provide a computer-implemented method and system that provides VAT information for European countries as well as the rest of the world.

A preferred method embodiment of the present invention includes receiving transaction information from a plurality of computerized invoice systems, determining value added tax information based on the transaction information, transmitting the value added tax information to the plurality of computerized invoice systems, receiving a value added tax amount for the business transaction determined by the plurality of computerized invoice systems based on the value added tax information, generating an at least one report based on the value added tax amount and the value added tax information. The transaction information can include at least shipping information. The value added tax information can include at least tax rate and tax type.

The preferred method embodiment of the present invention may additionally include receiving general ledger information and reconciling the value added tax information, the value added tax amounts, and general ledger information.

The determining step of the preferred method embodiment may include determining tax decision rules based on the transaction information to obtain value added tax information. The tax decision rules can be developed using a VTR table.

A preferred system embodiment of the present invention includes a computer system (including at least one server computer) for determining and reporting value added tax information of a business transaction. The preferred server computer is configured to receive transaction information from a plurality of computerized invoice systems, determine value added tax information based on the transaction information, transmit the value added tax information to the plurality of computerized invoice systems, receive a value added tax amount for the business transaction determined by the plurality of computerized invoice systems based on the value added tax information, and generate an at least one report based on the value added tax amount and the value added tax information. The transaction information can include at least shipping information. The value added tax information can include at least tax rate and tax type.

The preferred server computer of the present invention may be additionally configured to receive general ledger information and reconcile the value added tax information, the value added tax amounts, and general ledger information.

The preferred server computer of the present invention may be additionally configured to provide that value added tax information which is determined based on tax decision rules and the transaction information. The tax decision rules can be developed using a VTR table.

Another preferred method embodiment includes receiving transaction information from a plurality of computerized invoice systems and determining tax decision rules for the business transaction based on the transaction information. The transaction information can include at least country information and VAT transaction code. The tax decision rules can include at least tax type and tax rate. The tax decision rules can be developed using a VTR table.

### BRIEF DESCRIPTION OF DRAWINGS

The features of the present invention which are believed to be novel are set forth with particularity in the appended claims. The present invention, both as to its organization and manner of operation, together with further objects and advantages thereof, may best be understood with reference to the following description of the best mode for carrying out the invention, taken in connection with the accompanying drawings in which:

FIG. 1 is a schematic diagram illustrating a preferred embodiment of a system for implementing the present invention;

FIG. 2 is a block flow diagram illustrating a preferred methodology for implementing the present invention;

FIG. 3 illustrates a layout of a VAT reconciliation summary report in accordance with the present invention; and

FIG. 4 illustrates a layout of a VAT declaration summary report in accordance with present invention.

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific functional details herein are not to be interpreted as limiting, but merely as a representative basis for the claims and/or as a representative basis for teaching one skilled in the art to variously employ the present invention.

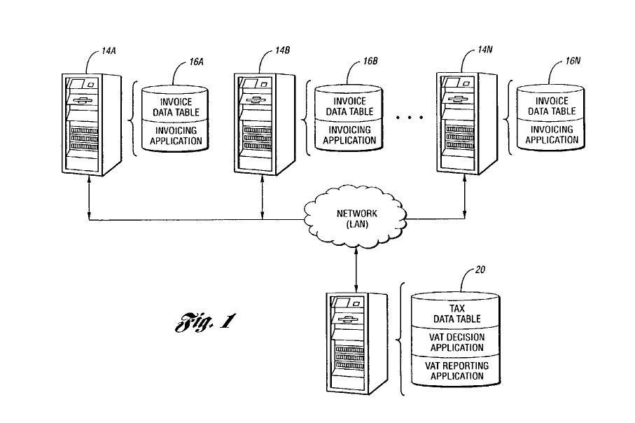

FIG. 1 is a schematic diagram illustrating a preferred system 10 for implementing the present invention. System 10 comprises at least one server computer 12 operably serving a plurality of invoice server computers 14A-14N. Invoice server computers 14A-14N are operably configured to execute invoice applications stored within storage 16A-16N. Invoice server computers 14A-14N are also operably configured to store information to, and retrieve data from, at least one invoice data table, preferably stored within storage 16A-16N, respectively.

In accord with a preferred embodiment of the present invention, invoice server computers 14A-14N communicate with server computer 12 utilizing a TCP-IP communication via network/LAN 18. Computer network 18 can comprise any one or more of a variety of computer communication configurations including but not limited to a local area network (LAN), a wide area network (WAN), a wireless network, an intranet, an extranet and the Internet.

Server 12 is configured to operably execute a VAT decision application and a VAT reporting application. The applications are preferably stored within storage 20. Server 12 is also configured to operably retrieve data from at least one global supplier data table.

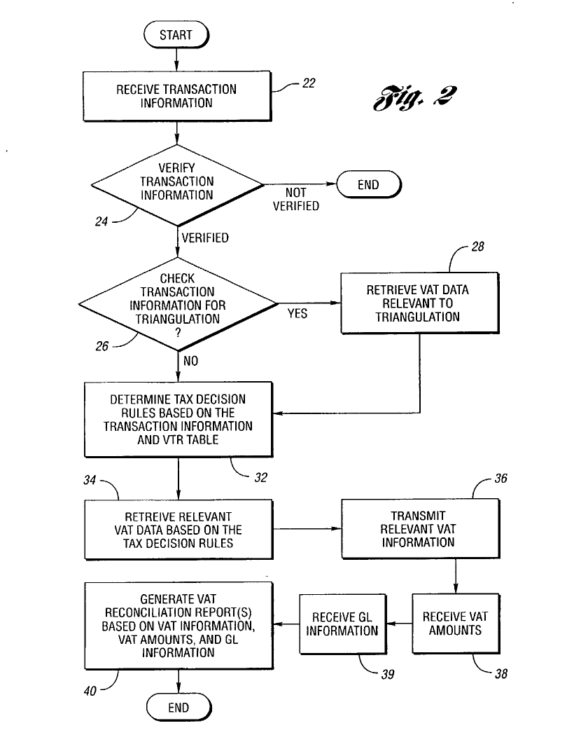

FIG. 2 is a block flow diagram illustrating a preferred methodology for implementing the present invention. As represented in block 22, transaction information is received, preferably from an invoice server computer 14. Invoice server computer 14 preferably retrieves the transaction data from the invoice data table and transmits the transaction information to VAT server 12 through network 18. In accord with a preferred embodiment, the invoice server computer transmits the transaction information in batch without user intervention while the invoice application creates invoices.

The transaction information can include, but is not limited to, invoice application name, shipment/billing locations (general supplier database (“GSDB”) codes), business unit codes, VAT transaction code (“VTC”), shipment date, invoice date and shipment/delivery terms. The shipment/billing locations can include ship-from, ship-to, bill-from, and bill-to locations. The GSDB codes can include ship-from, ship-to, bill-from, and bill-to GSDB codes. The GSDB codes can be five digit codes generated from a global supplier data table. The business unit codes can include ship-from, ship-to, bill-from, and bill-to codes. The business unit codes can be four digit codes used by a general ledger to identify a legal entity. The VTC identifies the transaction type, i.e., material or service. The shipment date refers to the date when the shipment took place if the transaction requires shipment. The shipment/delivery terms describe the terms of ship, i.e., ex-works. The transaction category can be material (production or non-production) or service and is derived from the VTC. The country information includes the countries involved in the transaction and is derived by reference to the GSDB for each of the shipment locations. The country is preferably stored in ISO country code format.

As represented in decision block 24, the transaction information is verified. The VAT decision application checks if certain transaction information, referred to as mandatory input parameters, has been received. The mandatory input parameters preferably comprise invoice application name, ship-from location, ship-to location, bill-from location, bill-to location, business unit (if applicable), VTC, shipment date, invoice date, and shipment/delivery terms. If any of the mandatory input parameters are missing, the VAT decision application transmits an error message to the invoice server computer 14 and VAT server 12 aborts execution of the VAT decision application. If all of the mandatory input parameters are present, the VAT server 12 retrieves GSDB data from global supplier data table.

Certain transaction information can be validated against the GSDB information, which can include shipment/billing locations (GSDB codes) and inter-company affiliate indication. If the transaction information cannot be validated, i.e., the transaction information is different than the GSDB information, the VAT decision application transmits an error message to the invoice server computer and VAT server 12 aborts execution of the VAT decision application. If the transaction information can be validated, the VAT decision application checks the transaction information for the present of triangulation.

As represented in decision block 26, the transaction information can be checked for the presence of triangulation. The VAT decision application analyzes the shipping/billing location information obtained from the GSDB, most notably the country information and the derived (based on VTC) transaction category, to check for the presence of triangulation.

Triangulation occurs when the invoicing route is different from the shipping route and involves three EU countries. For example, a direct cross-border shipment of goods from A to C with a third party located in country B. In this instance, two invoices are billed for the same shipment. The first invoice bills country B from country A and the second invoice bills country C from country B. All three shipment/billing locations must be VAT registered in their respective countries. The VAT consequences of this transaction include the first invoice exempt intra EC supply being included in the aggregate sales list (ASL) of country A. The VAT consequences of the second invoice include the declaration of Acquisition tax in country C.

As represented in block 28, if triangulation is present, tax data relevant to the triangulation is retrieved preferably from tax data table. The tax data preferably includes VAT and acquisition tax (AT) rules, tax rates and tax accounts. The tax information relevant to triangulation can be transmitted to invoice server 14, which is explained in more detail below.

As represented in block 32, the tax decision rules can be determined based on the transaction information. In accord with a preferred embodiment of the present invention, a VAT transaction rule (“VTR”) table can define tax decision rules based on the following criteria: (1) ISO country code, (2) VTC, and (3) the relationship between the tax entities involved. The VTC defines the type of material or service that is being purchased, i.e., production material, accounting services, transfer of know-how, etc. The relationship between the two countries can be: (1) domestic (i.e., within the same country), (2) intra European Community (“EC”) (between two countries within the EC), and (3) rest of the world (between two countries, one of which is outside of the EC). Based on the above criteria, the following details are obtained by the VAT decision application to make the appropriate tax decision: (1) the applicable tax type (i.e., VAT, non taxable, exempt, reverse charge (“RC”) and AT) and (2) the applicable rate type (i.e., full, reduced and zero). According to the present invention, the AT and RC are neutral taxes applied in the bill-to country and consist of equal and opposite entries to input and output VAT accounting. Under certain circumstances, these taxes replace VAT in the bill-from country.

Table 1 represents an example of a portion of a VTR table in accord with a preferred embodiment of the present invention. Each row in the VTR table defines the appropriate tax decisions for each country (abbreviated using the country's ISO country code) and VTC and its relationship to the other country involved in the transaction. An additional field (the VTR indicator) can also be present on the VTR table. The VTR indicator operates for countries that require a segregation of VAT accounting by commodity type. It is appended to the accounting details to provide the necessary segregation. This field does not affect the tax decision process. All values can be held against effective and expiration dates to enable decisions to be amended over time as a result of legal changes.

TABLE 1

| ISO | | | | | Rest of | | Rest of | | | |
|---|---|---|---|---|---|---|---|---|---|---|
| Country | | | Domestic | Intra EC | World | Intra EC | World | Effective | Expiration | VTR |
| Code | VTC | Rate Type | Code | Bill-From | Bill-From | Bill-To | Bill-To | Date | Date | Indicator |
| GB | AB | F | VAT | NT | NT | RC | RC | Jan. 1, 1998 | 9999-12-31 | |
| GB | AC | F | VAT | VAT | VAT | NT | NT | Jan. 1, 1998 | 9999-12-31 | |
| GB | AD | F | VAT | VAT | VAT | NT | NT | Jan. 1, 1998 | 9999-12-31 | |
| GB | B | F | VAT | NT | NT | RC | RC | Jan. 1, 1998 | 9999-12-31 | |
| GB | BA | F | VAT | NT | NT | RC | RC | Jan. 1, 1998 | 9999-12-31 | |
| GB | C | F | VAT | NT | NT | RC | RC | Jan. 1, 1998 | 9999-12-31 | |
| GB | D | F | VAT | VAT | VAT | NT | NT | Jan. 1, 1998 | 9999-12-31 | |
| GB | DA | R | VAT | EM | EM | EM | EM | Jan. 1, 1998 | 9999-12-31 | |
| GB | E | F | VAT | NT | NT | NT | RC | Jan. 1, 1998 | 9999-12-31 | |
| GB | FA | F | VAT | VAT | VAT | NT | NT | Jan. 1, 1998 | 9999-12-31 | |

For domestic transactions, a row of the VTR table is selected based on the country and VTC. The “Domestic Code” value of the selected row determines the appropriate tax treatment. Valid domestic tax treatments include VAT, non-taxable and exempt. Additionally, the rate type and VTR indicator from the selected row can be utilized for certain implementations of the present invention.

For intra EC transactions, a row of the VTR table is selected based on the ship-from country, bill-from country and VTC. From the selected row, the “Intra EC Bill-From” value determines the appropriate tax treatment on the bill-from side. Valid Intra EC tax treatments on the bill-from side include VAT, non-taxable and exempt. Subsequently, a row of the VTR table is selected based on the ship-to country, bill-to country and VTC involved. From the selected row, the “Intra EC Bill-To” column is used to determine the appropriate tax treatment on the bill-to side. Valid Intra EC tax treatments on the bill-to side include non-taxable, RC, AT, and exempt. The tax treatments on the bill-from and bill-to side are combined to derive the correct tax decision. If VAT is identified in the bill-from country row, then this treatment takes precedence over the bill-to tax treatment. For VAT, the rate type and VTR indicator are taken from the bill-from country row. For RC and AT, the rate type and VTR indicator are taken from the bill-to country row.

For rest of world transactions, a row of the VTR table is selected based on the ship-from country, bill-from country and VTC involved. From the selected row, the “Rest of World Bill-From” column is used to determine the appropriate tax treatment on the bill-from side. Valid rest of world tax treatments include VAT, non-taxable, and exempt. Subsequently, a row of the VTR table is selected based on the ship-to country, bill-to country and VTC involved. From the selected row, the “Rest of World Bill-To” column is used to determine the appropriate tax treatment on the bill-to side. Valid rest of world tax treatments include non-taxable, RC, AT, and exempt. The tax treatments on the bill-from and bill-to side are combined to derive the correct tax decision. If VAT is identified in the bill-from country, this treatment takes precedence over the bill-to tax treatment. For VAT, the rate type and VTR indicator are taken from the bill-from country row. For RC and AT, the rate type and VTR indicator are taken from the bill-to country row.

The VTR table entries of Table 2 are utilized to determine VAT information regarding various transactions in accord with a preferred embodiment of the present invention.

TABLE 2

| ISO | | | | | REST OF | | REST OF |
|---|---|---|---|---|---|---|---|
| COUNTRY | | RATE | | INTRA EC | WORLD BILL- | INTRA EC | WORLD |
| CODE | VTC | TYPE | DOMESTIC CODE | BILL-FROM | FROM | BILL-TO | BILL-TO |
| DE | AA | F | VAT | VAT | VAT | NT | NT |
| DE | AB | F | VAT | NT | NT | RC | RC |
| DE | 3 | F | VAT | EX | EX | AT | AT |
| GB | AA | F | VAT | VAT | VAT | NT | NT |
| GB | AB | F | VAT | NT | NT | RC | RC |
| GB | 3 | F | VAT | EX | EX | AT | AT |
| PL | 3 | F | VAT | EM | EX | EM | EM |

For example, a domestic transaction has a ship-from location of GB (Great Britain), ship-to location of GB, and a VTC of 3 (production material). Since the ship-from and ship-to countries are both GB, a row of the VTR table is selected to obtain a single GB country row against VTC code 3. The domestic column and rate type are then used to derive the tax decision. The VTR table entries of Table 2 are searched for a row in which the ISO country code equals GB and the VTC code equals 3, i.e., row 6 of Table 2. Accordingly, the domestic tax treatment is VAT and the rate type is F (Full).

As another example, Intra EC transaction (material) has a ship-from location of GB, ship-to location of DE (Germany), and a VTC code of 3 (production material). Since the ship-from and ship-to countries are different, the VTR table is accessed twice to obtain both a GB and DE country row against VTC 3. The “Intra EC” columns and rate type are then used to derive the tax decision. The appropriate tax treatment on the bill-from side based on an ISO country code GB and a VTC of 3, is EX (tax exempt), i.e., row 6 of Table 2. The appropriate tax treatment on the bill-to side based on an ISO country code of DE and VTC of 3, is AT and rate type is full, i.e., row 3 of Table 2. Acquisition tax in the bill-to country, AT with the bill-to rate is applicable based on the outcomes from both rows (6 and 3).

As yet another example, a rest of world transaction (material) has a ship-from location GB, ship-to of PL (Poland), and a VTC of 3 (production material). Since the ship-from and ship-to countries are different, the VTR table is accessed twice to obtain both a GB and PL country row against VTC code 3. The “Rest of World” columns are then used to derive the tax decision. The appropriate tax treatment on the bill-from side based on an ISO country code of GB and VTC of 3, is EX (tax exempt), i.e., row 6. The appropriate tax treatment on the bill-to side based on an ISO country code of PL and VTC of 3 is EX (tax exempt), i.e., row 7.

As represented in block 34, the tax decision rules are used to retrieve tax data relevant to the transaction from the tax data. The relevant tax information can generally include VAT types (i.e., VAT or AT), VAT rates (i.e., full, reduced, not taxable, etc.), VAT registration numbers, tax accounts (i.e., payable, receivable, base, contra, etc.), and invoice description (i.e., VAT exempt Intra Community Sale, etc.). If the transaction is exempt from VAT taxes, the VAT decision application preferably retrieves the following invoice description: “tax exempt due to cross-border supply according to paragraph three, number 2.” Specifically, the relevant tax data can also include, depending on the transaction, the following: VAT-Type-F, VAT-Type-T, Triangulation indication, Rate for VAT, Rate for AT, Tax Code, VAT number for Ship from, VAT number for Ship to, VAT number for Bill from, VAT number for Bill to, VAT Receivables Account, VAT Receivables Cost Center, VAT Receivables Tax Jurisdiction, VAT Payables Account, VAT Payables Cost Center, VAT Payables Tax Jurisdiction, VAT Base Tax Jurisdiction, AT Receivables Account, AT Receivables Cost Center, AT Receivables Tax Jurisdiction, AT Payables Account, AT Payables Cost Center, AT Payables Tax Jurisdiction, AT Base Account, AT Base Cost Center, AT Contra Account, AT Contra Cost Center, Reverse Charge (RC) Receivables Account, RC Receivables Cost Center, RC Payables Account, RC Payables Tax Jurisdiction, RC Base Account, RC Base Cost Center, RC Contra Account, RC Contra Cost Center, Invoice Text, Error Text, and Return Code.

As depicted in block 36, the relevant tax information is preferably transmitted to invoice server 14, which executes an invoice application preferably configured to determine the VAT amounts associated with the business transaction. The information can include VAT information relevant to triangulation if applicable to the transaction. The determined VAT tax information is preferably stored within invoice data table. Preferably, the invoice application posts the invoice, which includes the VAT tax information, to the general ledger and accounts receivable.

As depicted in block 38, the VAT amounts preferably determined by the invoice application are received from an invoice server computer 14.

As depicted in block 39, the GL information posted by the invoice application is received by an invoice server computer 14.

As depicted in block 40, VAT reconciliation reports can be generated based on the VAT information, VAT amounts, and GL information.

The following is a description of the reconciliation process in accordance with the present invention to produce reconciliation reports: The invoice applications, which interface with the VAT decision and reporting applications, also transmit information to an at least one general ledger (GL) data table that is preferably stored on a general ledger server. One of the prerequisites to ensure a proper reconciliation process is that every invoice application transmits information to the GL data table and VAT applications within the same process and at about the same time.

Within the GL data table there are preferably two fields, which describe VAT related data. The first field is the account, which contains the specific tax account. There are only two accounts for VAT, preferably referred to as the 18P01 and the 06T02 account. The second field is the tax jurisdiction code field which contains detailed information about the kind of VAT, and also the tax rate.

After the information has been transmitted to the GL data table, the VAT reporting application receives two files from the GL data table. The files contain tax related ledger data, i.e., all GL journals to VAT accounts 18P01 and 06T02 and all journals with a non-blank tax jurisdiction code. One file is a daily extract from the GL data table and the other one a month to date file, which contains the data for a complete accounting month. The daily extract contains the input from the last GL edit and post run and is used for daily reconciliation reports, whereas the month to date file is used for monthly reconciliation reports.

The VAT information, VAT amounts, and GL information is used to produce reconciliation reports. One such report, preferably referred to as the VAT reconciliation report contains the following information: the GL amounts and the VAT amounts for an invoice system/base account/tax jurisdiction combination and shows the difference. This report is preferably produced daily for a daily reconciliation and monthly for a monthly reconciliation.

There is another group of reconciliation reports which compare the GL amount, which has been posted to VAT accounts for the VAT types (VAT, AT and RC) with the calculated VAT/AT/RC amount in the VAT reconciliation report (detail and summary reports described in more detail below). This report shows the GL amounts by account for a given feeder system/tax jurisdiction combination. It then calculates the VAT amount by using the information provided in the tax jurisdiction code, compares the calculated VAT amount to the posted VAT amount and shows the difference. This report is used for a monthly reconciliation.

Other VAT reconciliation reports include the reconciliation detail report and VAT reconciliation report.

The VAT reconciliation detail report can include, but is not limited to, the following information: interface code, tax jurisdiction code, base account, amount in ledger currency, calculated amount in ledger currency, posted VAT amount in ledger currency, difference in ledger currency, and subtotal tax jurisdiction code.

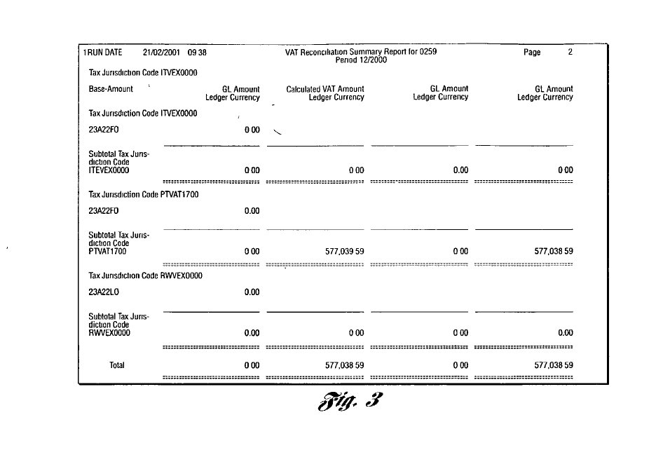

FIG. 3 illustrates a layout of a VAT reconciliation summary report in accordance with the present invention. This report can include, but is not limited to, the following information: jurisdiction tax code, base account general ledger amount in ledger currency, calculated VAT amount in ledger currency, and posted VAT amount in ledger currency. The difference between (1) the calculated VAT amount, and (2) the posted VAT amount can also be included on the report. It should be understood that the layout of the VAT reconciliation summary report can be rearranged, modified, and reconfigured to best fit implementation of the present invention.

It should be understood that other VAT reports not pertaining to reconciliation based on VAT information and VAT amounts can be generated. Preferably, the invoice server transmits the VAT information and amounts to server 12 for VAT report generation by VAT reporting application. Preferably, the VAT information and amounts are stored in VAT data table contained within storage 20. According to the present invention, VAT reports can be generated in detail and summary form for VAT declarations, aggregate sales lists (ASL), ATs, RCS, and input VAT declarations. The ASL includes a list of all cross-border transactions that are tax exempt in country A and subject to tax in country B.

The VAT declarations detail report can include, but is not limited to, the following information for business transactions: non-taxable/taxable transactions, bill-to region, VAT rate, invoice currency, bill-to company, interface code, VTC, DT (document type), invoice number, shipment or service date, net value in invoice currency, net value in ledger currency, and VAT amount in invoice currency. Subtotals for taxable transactions, subtotal for VAT-rates, subtotal for invoice currency, subtotal for bill-to region, and total for business unit can also be included in this report.

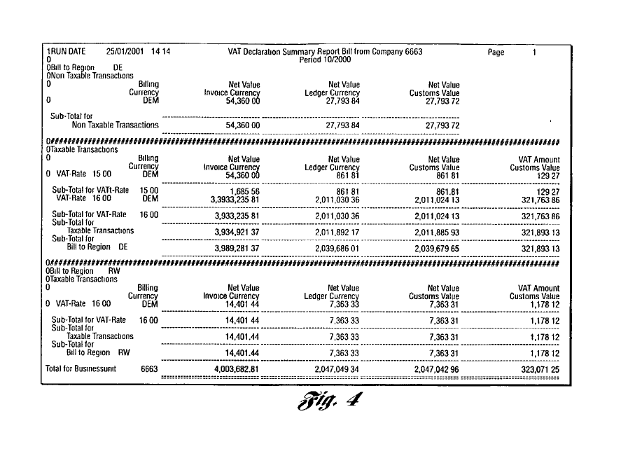

FIG. 4 illustrates a layout of a VAT declaration summary report in accordance with a preferred embodiment of the present invention. This report can include, but is not limited to, the following information for business transactions: non-taxable/taxable transactions, bill-to region, VAT rate, billing currency, net value in the invoice currency, net value in the ledger currency, net value according to customs value, VAT amount according to customs value, subtotal for VAT-rate, subtotal for taxable transactions, subtotal for bill-to region, and total for business unit. It should be understood that the layout of the VAT declaration summary report rearranged, modified, and reconfigured to best fit implementation of the present invention.

The ASL detail report can include, but is not limited to, the following information: bill to company, VAT identification, interface code, VTC, document type, invoice number, shipment date, invoice currency, value in invoice currency, value in ledger currency and triangulation flag. The report can also include subtotal for the bill-to company, subtotal for invoice currency, subtotal for triangulation, and subtotal for business unit.

The ASL summary report can include, but is not limited to, the following information: bill-to company, VAT identification, billing currency, net value in invoice currency, net value in ledger currency, net value in customs value, triangulation flag, subtotals for transactions with triangulation flags, and total for business unit.

The acquisitions tax detail report can include, but is not limited to, the following information: VAT rate, invoice currency, bill-from company, interface code, VTC, DT, invoice number, shipment or service date, triangulation flag, subtotal for different VAT rates, net value in the invoice currency, net value in the ledger currency, and VAT amount invoice currency, subtotal for invoice currency, subtotal for triangulation, and total for business unit.

The acquisition tax summary report can include, but is not limited to, the following information: triangulation flags, VAT rate, invoice currency, net value invoice currency, net value ledger currency, net value customs value, VAT amount customs value, subtotal for triangulation transactions, total for business unit transactions.

The reverse charge detail report can include, but is not limited to, the following information: invoice currency, VAT rate, bill from company, interface code, invoice number, VTC, DT, shipment or service date, net value in invoice currency, net value in ledger currency, VAT amount in invoice currency, subtotal for different VAT rates, and subtotal for invoice currency, and total for business unit.

The reverse charge summary report can include, but is not limited to, the following information: VAT rate, invoice currency, net value invoice currency, net value ledger currency, net value customs value, and VAT amount customs value, total for business unit.

The input VAT declarations detail report can include, but is not limited to, the following information: bill from country, VAT rate, invoice currency, VTC group, VTC bill from company, interface code, DT, invoice number, shipment or service date, net value invoice currency, net value ledger currency, VAT amount invoice currency, subtotal for VTC group, subtotal for invoice currency, subtotal for VAT rate, subtotal for bill from country, and total for business unit.

The input VAT declaration summary report can include, but is not limited to, the following information: bill from country, VAT rate, invoice currency, VTC group, net value invoice currency, net value ledger currency, net value customs value, VAT amount customs value, subtotal for VAT rate, subtotal for bill from country, and total for business unit.

While the best mode for carrying out the invention has been described in detail, those familiar with the art to which this invention relates will recognize various alternative designs and embodiments for practicing the invention as defined by the following claims.

1. A computer-implemented method for determining and reporting value added tax information of a business transaction, the method comprising:
receiving transaction information from a plurality of computerized invoice systems;
determining value added tax information based on the transaction information;
transmitting the value added tax information to the plurality of computerized invoice systems;
receiving a value added tax amount for the business transaction determined by the plurality of computerized invoice systems based on the value added tax information; and
generating an at least one report based on the value added tax amount and the value added tax information.

2. The computer-implemented method of claim 1 further comprising receiving general ledger information.

3. The computer-implemented method of claim 2 wherein the general ledger information includes at least tax account information and tax jurisdiction information.

4. The computer-implemented method of claim 3 further comprising reconciling the value added tax information, the value added tax amounts, and general ledger information.

5. The computer-implemented method of claim 1 wherein the determining step includes determining tax decision rules based on the transaction information to obtain value added tax information.

6. The computer-implemented method of claim 5 wherein the tax decision rules are developed using a VTR table.

7. The computer-implemented method of claim 1 wherein the transaction information includes at least shipping information.

8. The computer-implemented method of claim 1 wherein the value added tax information includes at least tax rate and tax type.

9. A computer-implemented system for determining and reporting value added tax information of a business transaction, the system comprising at least one server computer operably serving at least one client computer, the at least one server computer configured to:
receive transaction information from a plurality of computerized invoice systems;
determine value added tax information based on the transaction information;
transmit the value added tax information to the plurality of computerized invoice systems;
receive a value added tax amount for the business transaction determined by the plurality of computerized invoice systems based on the value added tax information; and
generate an at least one report based on the value added tax amount and the value added tax information.

10. The computer-implemented system of claim 9 wherein the at least one server computer is further configured to receive general ledger information.

11. The computer-implemented system of claim 10 wherein the general ledger information includes at least tax account information and tax jurisdiction information.

12. The computer-implemented system of claim 11 wherein the at least one server computer is further configured to reconcile the value added tax information, the value added tax amounts and general ledger information.

13. The computer-implemented system of claim 9 wherein the value added tax information is determined based on tax decision rules and the transaction information.

14. The computer-implemented system of claim 13 wherein the tax decision rules are developed using a VTR table.

15. The computer-implemented system of claim 9 wherein the transaction information includes at least shipping information.

16. The computer-implemented system of claim 9 wherein the value added tax information includes at least tax rate and tax type.

17. A computer-implemented method for determining tax decision rules for a business transaction, the method comprising:
receiving transaction information from a plurality of computerized invoice systems, the transaction information including at least country information and VAT transaction code; and
determining tax decision rules for the business transaction based on the transaction information, the tax decision rules including at least tax type and tax rate.

18. The computer-implemented method of claim 17 wherein the tax decision rules are developed using a VTR table.

19. The computer-implemented method of claim 18 wherein the tax decision rules are used to obtain value added tax information.

20. The computer-implemented method of claim 19 wherein the value added tax information is used to generate an at least one report.
